(19) United States
(12) Patent Application Publication
(10) Pub. No.: US 2025/0315772 A1
(43) Pub. Date: Oct. 9, 2025

(54) BAGGAGE NOTIFICATION SYSTEM AND METHOD

(71) Applicant: SITA Information Networking Computing UK Limited, Hayes (GB)

(72) Inventor: James PEACOCK, Hayes (GB)

(21) Appl. No.: 19/185,748

(22) Filed: Apr. 22, 2025

Related U.S. Application Data
(63) Continuation of application No. PCT/EP2023/079500, filed on Oct. 23, 2023.

(30) Foreign Application Priority Data
Oct. 25, 2022 (GB) 2215792.9
Oct. 25, 2022 (GB) 2215795.2

(51) Int. Cl. G06Q 10/083

(52) U.S. Cl. CPC G06Q 10/083

(57) ABSTRACT

There is provided a system for notifying a delayed arrival of an item at a destination, wherein, according to an original schedule, the item and a passenger associated with the item are scheduled travel from an origin and arrive at a destination at an original scheduled arrival time, the system comprising: a processor configured to: retrieve delayed item data indicating that the item will arrive at the destination later than the passenger; and send a first notification to a mobile and/or a user-accessible device that is/are accessible by the user, the notification informing that the item and the passenger will arrive at different arrival times at the destination.

### CROSS-REFERENCE TO RELATED APPLICATIONS

This application is a continuation of International Patent Application No. PCT/EP2023/079500, filed Oct. 23, 2023, entitled “BAGGAGE NOTIFICATION SYSTEM AND METHOD,” which claims priority to Great Britain Patent Application No. 2215792.9, filed Oct. 25, 2022 and Great Britain Patent Application No. 2215795.2, filed Oct. 25, 2022, all of which are incorporated by reference in their entireties herein.

### FIELD OF THE INVENTION

This invention relates to item handling and tracking methods and systems. It is particularly, but not exclusively, concerned with baggage handling methods and systems, for example operating at airports, seaports, train stations, other transportation hubs or travel termini.

### BACKGROUND OF THE INVENTION

As the volume of items being transported globally continuously increases, with the Air Transport Industry alone transporting over 4 billion bags annually, the handling and tracking of items is becoming increasingly challenging. In particular, despite the advances in baggage handling and tracking technologies in recent years, the number of mishandled bags still remains high. For example, according to SITA (Société Internationale de Télécommunication Aéronautique)'s 2019 report, over 28 million bags were mishandled in 2018.

In order to reduce the number of mishandled bags (e.g. delayed, damaged, or misplaced bags), various item handling and tracking solutions for reducing the number of mishandled bags have been developed and deployed in recent years. However, even with the state-of-the art solutions for reducing mishandling of bags and the highest level of care, there are still likely to be mishandled items due to unforeseen factors. It is therefore important to provide a post-mishandling solution to minimise the impact of the mishandling, such as severe delays in eventual delivery of the mishandled items. As such delays may, in turn, increase the chance of the items being lost or damaged, providing a method and a system that can quickly identify and re-route mishandled items is essential for reducing losses for both the party responsible for handling items and the owners of the items.

We have appreciated that existing solutions for handling mishandled items, particularly when mishandling of the bags caused items to miss their original departure journey (e.g. departure flight) from the origin, involve additional steps, and in some cases, transfer of items to multiple locations prior to re-routing of the items. These additional steps often require manual intervention by human operators, which can lead to a further delay of the eventual delivery of the items.

Although this problem has been explained in the context of baggage handling it applicable to any logistics process in a hub-and-spoke model, involving the transfer of an item (such as, but not limited to, cargo, parcel or mail) which has to go through consecutive tasks with checkpoints and where the items may be at risk of not being delivered to the destination on time.

Another common problem faced by passengers globally is the wait and hassle associated with their mishandled baggage in the airport baggage hall. Typically, a passenger only finds out that their baggage was mishandled after having waited at a baggage carousel whilst all other items from the passenger's flight are delivered. This is time-consuming and frustrating for the passenger, and such a passenger experience can also be detrimental to the reputation of the airline.

In addition, once the passenger has realised that their baggage has been mishandled, the passenger then needs to locate a baggage service desk in the airport baggage hall. Such a service desk is sometimes operated by an individual airline, however, is often a ground handler's baggage desk, servicing multiple airlines. This means that the passenger will be required to join a queue with passengers from multiple airlines.

Furthermore, once the passenger has reached the front of the queue, they will be required to provide details of their delayed baggage including, their flight details, their baggage details including a description of the colour, type and design, their address details, and a customs declaration to clear the baggage for delivery back to the passenger. As such procedures are often conducted in English or a local language, which may not be the passenger's first language, this can further slow down the process and may also lead to errors in the details.

To date, in order to mitigate some of abovementioned issues, some airlines have invested in building their own passenger notification system. However, such notification systems are airline-specific, therefore, lack functionality to track the bag across multiple airlines. Moreover, such airline-specific systems are built to operate based on the airline's own back-end processers. This means that sharing such systems with other airlines is impossible or difficult due to technical incompatibility as well as potential conflict of interest.

### SUMMARY OF THE INVENTION

According to a first aspect of the invention, there is provided a system for notifying a delayed arrival of an item at a destination, wherein, according to an original schedule, the item and a passenger associated with the item are scheduled travel from an origin and arrive at a destination at an original scheduled arrival time, the system comprising: a processor configured to: retrieve delayed item data indicating that the item will arrive at the destination later than the passenger; and send a first notification to a mobile and/or a user-accessible device that is/are accessible by the user, the notification informing that the item and the passenger will arrive at different arrival times at the destination.

According to a second aspect of the invention, there is provided an item handling system for moving an item between an origin and a destination according to a first scheduled route which departs the origin at a first predetermined departure time, wherein the system comprises: processor configured to: determine whether the item has missed the first predetermined departure time of the first scheduled route; determine the destination for the item; determine a new, second, scheduled route between the origin and the determined destination wherein the second scheduled route departs the origin at a second predetermined time which is after the first predetermined time; and process the item according to the second scheduled route.

According to a third aspect of the invention, there is provided a mobile device for communicating with an item handling system for moving an item between an origin and a destination, wherein if the item handling system determines that the item has been re-routed to a new, second, route to the destination that is different from an original, first, route to the destination, the mobile device is configured to receive a notification from the item handling system, the notification comprising details relating to the second route,

According to a fourth aspect of the invention, there is provided a user-accessible device for communicating with an item handling system for moving an item between an origin and a destination, wherein if the item handling system determines that the item has been re-routed to a new, second, route to the destination that is different from an original, first, route to the destination, the user-accessible device being configured to: receive second itinerary data from the item handling system, the second itinerary data comprising details relating to the second route; and display the second itinerary data to a passenger associated with the item.

According to a fifth aspect of the invention, there is provided an item handling system for moving an item between an origin and a destination according to a first scheduled route which departs the origin at a first predetermined departure time, wherein the system comprises: processor; storage medium; a reader; and at least one conveyor system for conveying the item wherein the processor is configured to: receive data associated with a tracker associated with the item; retrieve a first itinerary data associated with the data associated with the tracker using the reader; determine, based on the first itinerary data, if the item has missed a first predetermined departure time of the first scheduled route; if it is determined that the item has missed the first predetermined departure time, determine a new, second, route between the origin and the destination; add second itinerary data relating to the determined second scheduled route to the storage medium, the second itinerary data comprising: a second predetermined departure time, a departing point within the origin according to the second scheduled route, and a physical path between the origin and destination according to the first scheduled route; and control the at least one conveyor system to convey the item to the departing point.

According to a sixth aspect of the invention, there is provided a method for moving an item between an origin and a destination according to a first scheduled route which departs the origin at a first predetermined departure time, wherein the method comprises steps of: determining whether the item has missed the first predetermined departure time of the first scheduled route; determining the destination for the item; determining a new, second, scheduled route between the origin and the determined destination wherein the second scheduled route departs the origin at a second predetermined time which is after the first predetermined time; and processing the item according to the second scheduled route.

According to a seventh aspect of the invention, there is provided a method for moving an item between an origin and a destination according to a first scheduled route which departs the origin at a first predetermined departure time, wherein the method comprises steps of: receiving data associated with a tracker associated with the item; retrieving a first itinerary data associated with the data associated with the tracker using the reader; determining, based on the first itinerary data, if the item has missed a first predetermined departure time of the first scheduled route; if it is determined that the item has missed the first predetermined departure time, determining a new, second, route between the origin and the destination; adding second itinerary data relating to the determined second scheduled route to a storage medium, the second itinerary data comprising: a second predetermined departure time, a departing point within the origin according to the second scheduled route, and a physical path between the origin and destination according to the first scheduled route; and controlling at least one conveyor system to convey the item to the departing point.

Optional features are defined in dependent claims.

### BRIEF DESCRIPTION OF THE DRAWINGS

An embodiment of the invention will now be described, by way of example only, and with reference to the accompanying drawings, in which:

FIG. 1 is a schematic diagram of exemplary components of the item handling system according to an embodiment of a first aspect of the invention;

FIG. 2 is a schematic diagram of an exemplary process of handling baggage using the item handling system according to an embodiment a first aspect of the invention;

FIG. 3 is a flow diagram of an exemplary process of performing a method for moving an item between an origin and a destination according to an embodiment a first aspect of the invention;

FIG. 4 is a flow diagram of an exemplary process of performing a method for moving an item between an origin and a destination according to another embodiment a first aspect of the invention;

FIG. 5 is a schematic diagram of an exemplary mobile device according to an embodiment a first aspect of the invention;

FIG. 6 is a schematic diagram of an exemplary user-accessible device according to an embodiment a first aspect of the invention;

FIG. 7 is a schematic diagram of an exemplary delayed bag alert system according to an embodiment of a second aspect of the invention, illustrating an exemplary process flow;

FIG. 8 is a schematic diagram of an exemplary delayed bag alert service module according to an embodiment of a second aspect of the invention, illustrating interactions between the delayed bag alert service module and other modules(s) and/or system(s);

FIG. 9 is a schematic diagram of an exemplary trigger design (left), and an example FORWARD (FWD) message (right), according to an embodiment;

FIG. 10 a schematic diagram of an exemplary message generation and message delivery with a timer for delayed delivery of the message, according to an embodiment;

FIG. 11 a schematic diagram of an exemplary messages in a form of an email (left) and an SMS (right), according to embodiments; and

FIG. 12 a schematic diagram of an exemplary process of using a self-service, according to an embodiment.

### DETAILED DESCRIPTION

The following exemplary description is based on a system, apparatus, and method for use in the aviation industry. However, it will be appreciated that the invention may find application outside the aviation industry and in any industry, such as in another travel industry, packaging or delivery industry, in which items such as bags, suitcases, packaged items, parcels, or mails are transported. Thus, embodiments of the invention find application in the travel and transportation industry in general, such as rail, coach, car, vessel, as well for delivery and courier services.

As used herein, the term “RUSH Baggage” means a passenger's baggage which has not accompanied the passengers on their booked flight/s and is directed to an alternative flight in order to be restored to that/those passengers.

When an item is mishandled at an origin, such as an origin airport, the mishandled item may miss a scheduled departure, such as a scheduled departure flight. Such mishandling may, for example, be caused by delayed arrival of the item at the origin, by delayed handling of the item, by the item being damaged whilst handling the item, or the item being misplaced or lost. If, as a result of such mishandling, the item was not able to be loaded onto the scheduled departure flight, the item needs to be re-routed so that the item can reach a destination via an alternative route. As a result, the re-routed item will depart the origin on an alternative flight at a later departure time than the original departure time of the original flight. The physical path of the alternative route may be different from that of the original route. For example, the alternative route may comprise multiple legs and/or segments with one or more intermediate points between the departure from the origin and the arrival at the destination.

In various existing solutions, re-routing of a mishandled item requires physically modifying a tracker (e.g. a label, RFID tag or barcode) attached to the item or replacing it with a new tracker. In other words, in order to re-route a mishandled item using the existing solutions, an original tracker attached to the item, including original route information, needs to be replaced with a new or modified tracker, including new route information. This is because the existing solutions rely on information displayed on tracker for transporting items. However, the need to perform an additional step of replacing or modifying tracker (e.g. re-labelling) inevitably means that the items need be transported to a suitable facility for replacing or modifying tracker (e.g. re-labelling station), or require a human operator to manually track the item to replace or modify the tracker.

The present invention, alongside other technical advantages it provides, may provide a system and a method for re-routing mishandled items without the need to replace or modify tracker, thereby avoiding further delays and use of additional resources during the step of replacing or modifying the tracker.

The origin in the following exemplary description is an airport. However, it will be appreciated that the origin in other embodiments may be one of: a train station, a sea port, and a parcel handling hub or another origin.

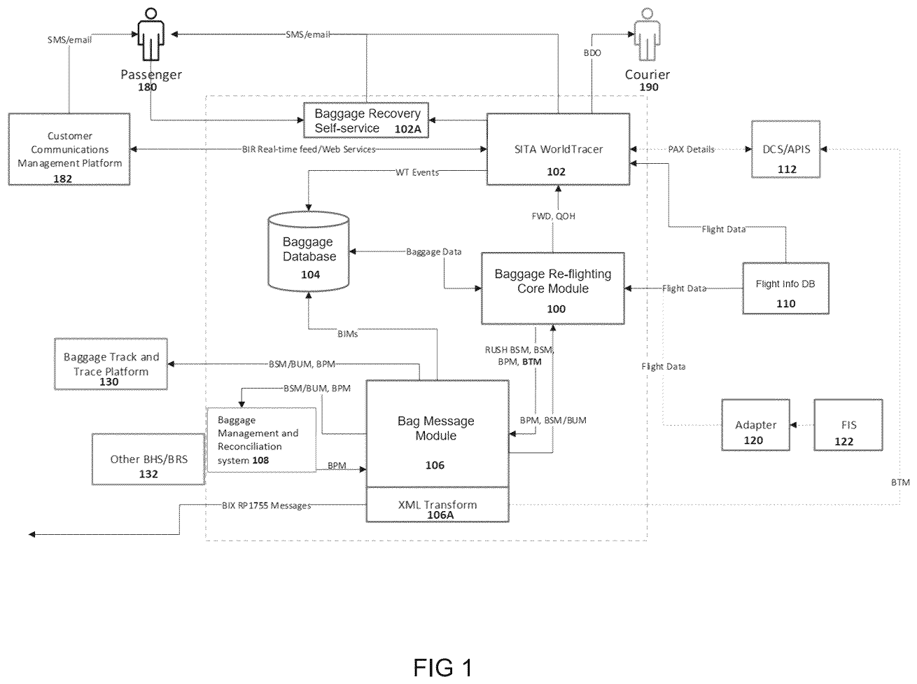

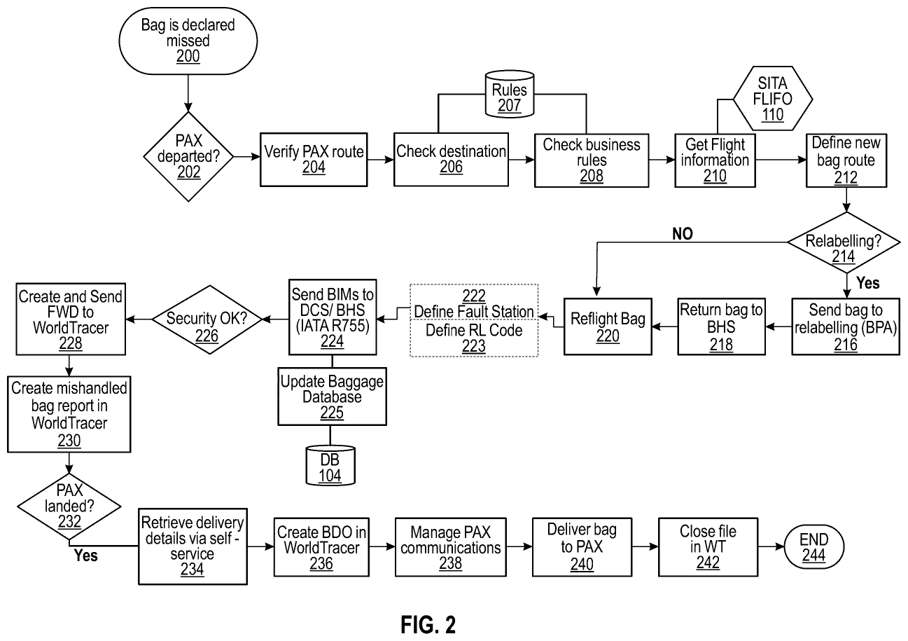

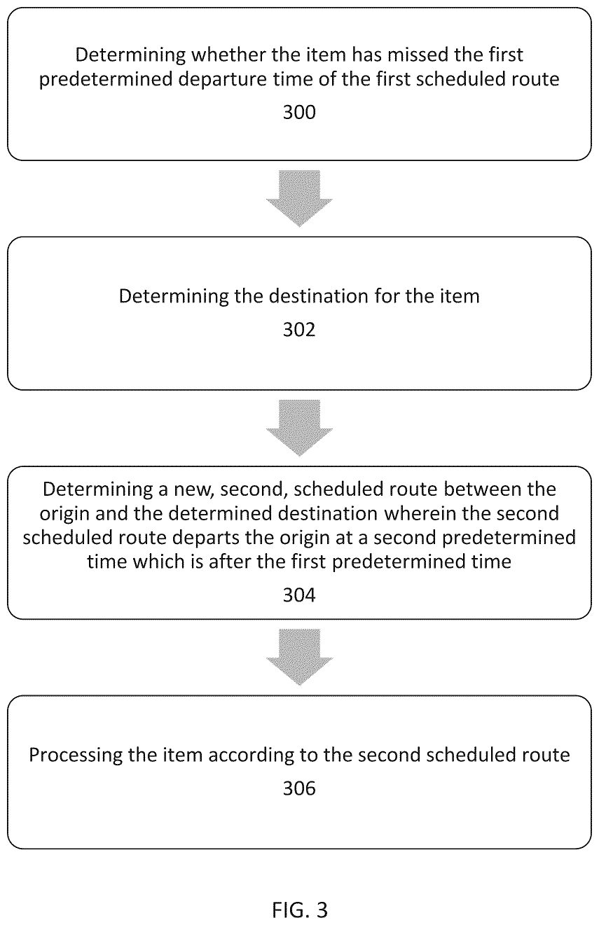

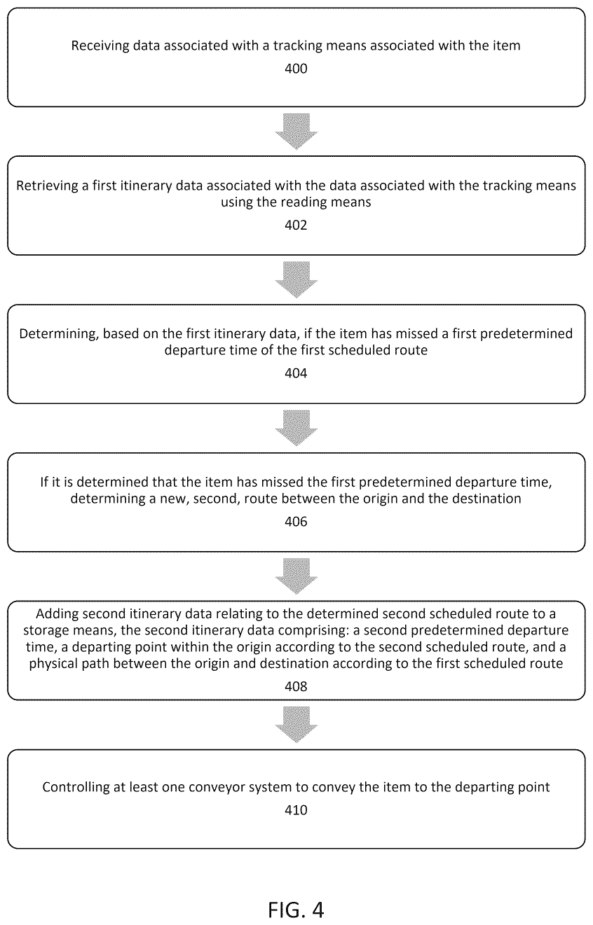

An embodiment of the invention will now be described referring to FIG. 1 illustrating the exemplary component diagram of an item handling system, and FIG. 2 illustrating an exemplary process diagram of handling an item using the item handling system. However, from the following description, it will be clear that embodiments of the invention may reside in any one of the components shown in FIG. 1 or as the item handling system as a whole. It will also be clear that the process illustrated in FIG. 2 is an example according to an embodiment, and in other embodiments some of the steps shown in FIG. 2 may be missing and/or be performed in a different order.

When an item is mishandled at an origin airport, the mishandling may often cause sufficient delay for the item to miss the originally scheduled departure. In some cases, if the origin airport is not the first point of the item's overall journey, such delay may be at least partly due to delayed arrival of the item at the origin airport. In some cases, such delays may at least be partly due to one or more unforeseen events (e.g. natural disaster) other than mishandling of the item. If the item misses the originally scheduled departure to a destination for any of the aforementioned reasons, the item handling system embodying the present invention can determine a new route to the destination and transport the item according to the new route.

The Item handling system comprises a processing means that is configured to determine whether an item has missed its first predetermined departure time (i.e. the departure time according to the originally schedule) of the first scheduled route (i.e. the original route). The processing means may control one or more components of the item handling system. In the example item handling system illustrated in FIG. 1, the processing means controls a Baggage Re-Flighting Core module (100), Baggage Database module (104), and Bag Message module (106). Whether an item has missed its original departure flight may be determined based on baggage information stored in a Baggage Database (104). The Baggage Database (104) may retrieve such information from a message from a baggage handling system (BHS) that handled the item. Baggage Handling Systems are well known in the art and in such cases, the BHS may be equipped with or connected to a suitable baggage tracking system that generates location logs of items being handled with corresponding timestamps. The baggage tracking system may, for example, track the item by using one or more suitable computer vision techniques and/or by retrieving information from a machine readable element of the tracker (e.g. a RFID chip, 2D barcode, QR code, or printed text for optical character reading (OCR)) attached to the item. The processing means may also compare the location history of the item and flight information database (110) to determine that bag has missed the original departure flight. For example, if baggage data indicates that the item is still at the origin airport after departure of the original departure flight, it may be determined that the item has missed the original departure flight.

As shown in FIG. 2, once it has been determined (200) that the item has missed the original departure flight, the processing means may optionally determine (202) whether a person associated with the item (e.g. a passenger who checked-in the item, or a person who is responsible for carrying or delivering the item to the destination) has departed the origin. For this, the processing means may identify the passenger associated with the item from the Baggage Database (104) and Advance Passenger Information System (APIS) (112), and retrieve boarding history of the passenger from a departure control system (DCS) (112).

Performing this step enables the item handling system to determine how the item should be re-routed. For example, in the case that the passenger who checked-in the item also missed the original departure flight, it may be beneficial to return the item to the passenger at the origin. Furthermore, in the case that the passenger decides to depart on an alternative flight, it may be beneficial to re-route the item to be loaded to the aircraft of the alternative flight.

If it has been determined that the passenger departed (202) the origin but the item missed (200) the original departure flight, the processing means then determines (206) a destination to which the item should be transported. In most cases, the destination to which the item should be transported will match the original destination of the item and the passenger. However, in the cases that the passenger departed the origin on a different flight having a different destination from that of the original departure flight, it may be beneficial to re-route the item to the said different destination. For this, the processing means may retrieve (204) flight details associated with the passenger and the boarding history of the passenger from APIS and DCS (112).

Once the destination to which the item should be transported has been determined, the processing means determines (212) a new, second, scheduled route between the origin and the determined destination of the item. The new route may be determined (212) by taking into account various factors, such as baggage handling agreement between a plurality of carriers, load limits of alternative flights, preferred routes and preferred carriers.

The factors to be taken into account when determining the new route may be defined as rules (207) that can be configured by various users of the item handling system (e.g. airlines, couriers, passengers and airport).

The rules (207) may be configured to specify preferred airlines for re-routing mishandled items. For example, the rules (207) may be configured to specify that mishandled items should preferably be handled by the same airline as the airline of their original departure flights or by airlines in the same alliance. The preferred airlines may also be ranked in multiple tiers according to the degree of preference. The rules (207) may also be configured to avoid certain airlines (e.g. airlines that have no baggage handling agreement).

The rules (207) may also be configured to allow or disallow re-routing of mishandled items via non-direct routes (i.e. routes comprising multiple legs and/or segments with one or more additional intermediate stops). In the cases that the rules (207) allow re-routing of mishandled items via non-direct routes, the rules (207) may further specify that direct routes are preferred over non-direct routes, and/or non-direct routes having fewer intermediate stop(s) are preferred over those having higher number of intermediate stops.

The rules (207) may also be configured to specify the maximum duration of the expected total journey time to the destination. In such cases, the rules (207) may further specify that routes having shorter expected total journey time(s) are preferred over those having longer expected total journey time.

If the rules (207) include multiple preferences, the preferences may be ranked in multiple tiers according to the degree of importance. In such cases, one or more preferences of lower tier(s) may be overruled in favour of one or more preferences of higher tier(s).

In some cases, one or more preferences specified in the rules (207) may be overruled based on one or more physical limitations. For example, if the most preferred flight according to the preferences specified in the rules (207) has reached or nearly reached its maximum load capacity, a less preferred flight having sufficient free capacity may need to be selected to avoid overloading or unsuccessful loading. Another example of such physical limitations is lead time to a loading point. In other words, if the most preferred flight according to the preferences specified in the rules (207) is likely to depart before the item can reach the loading point of the flight, a less preferred flight having a later departure time and/or a loading point located closer to the current location of the item may need to be selected to avoid unsuccessful loading.

Optionally, such physical limitations may be included in the rules (207).

In order to determine the new scheduled route between the origin and the determined destination of the item, the processing means retrieves (210) flight information of one or more candidate re-route flights from the flight information database (110). In the example shown in FIG. 2, this step is performed after the step of checking (208) the rules (207) for selecting re-route flights. However, in other embodiments, the item handling system may determine the new schedule route without take such rules (207) into account. In such cases, the next available flight to the destination may be selected as the new scheduled route.

Based on the retrieved flight information, and optionally the rules (207) specifying preferences for selecting a re-route flight (RUSH flight), the processing means determine the new scheduled route for the item to be re-routed.

In existing re-routing solutions, assigning a new route for an item and processing the item according to the new route requires re-labelling (214). In other words, re-routing using existing solutions requires an original tracker (e.g. a label, RFID tag or barcode) attached to the item, including original route information, to be replaced with a new or modified tracker, including new route information. This means that the items need be transported (216) to a suitable facility for replacing or modifying tracker (e.g. re-labelling station (BPA)), and then returned (218) to the baggage handling system (BHS) for processing. These additional steps leads to further delays and use of additional resources.

The item handling system embodying the present invention, alongside other technical advantages it provides, provides a way to re-route (220) mishandled items without the need to replace or modify the tracker. In order to enable this, the processing means may add (224, 225) second itinerary data relating to the new scheduled route to a storage means (104) storing first itinerary data associated with item. The first itinerary data includes the origin, the destination, the original departure time, and a physical path between the origin and destination according to the original scheduled route. The second itinerary data may include a new departure time according to the new scheduled route and a physical path between the origin and destination according to the new scheduled route.

As a result, the second itinerary data added to the storage means, as well as the first itinerary data, is associated with the original tracker. This, in turn, enables the BHS to automatically transport the item according to the second itinerary data by reading the machine-readable element of the original tracker. For example, if the RUSH flight departs from a new departing point within the origin that is different from that of the original flight, the BHS may transport the item from the original departing point to the new departing point.

Optionally, the first itinerary data that are different from the second itinerary data may be removed from the storage means (104). This reduces the storage space required to store itinerary data for re-routed bag.

Optionally, the BHS may comprise a plurality of reading means for automatically reading the machine readable element of the tracker so that the processing means can:
retrieve the current location of the item;
retrieve the location of the new departing point of the item; and
control one or more conveyor systems of the BHS to automatically convey the item to the new departing point.

Optionally, the processing means may retrieve and check (226) information relating to any security requirement(s) to be met in order for the item to travel on the re-route flight (RUSH flight). Such information may be retrieved from one or more of: the carrier (e.g. airline) operating the RUSH flight, local authority of one or more of the destinations of the RUSH flight, and one or more of the destination passenger terminals (e.g. airport) of the RUSH flight. Such information may include requirement(s) and/or restriction(s) in relation to: contents of the item, weight of the item, dimensions of the item, origin of the item, destination of the item, airline rules, airport rules, and any required pre-approval status of the passenger and/or the item.

This step may be performed at any stage after the RUSH flight has been determined based on the rules (207) specifying preferences for selecting a RUSH flight, but before the item is loaded onto the aircraft of the RUSH flight. If the security requirement(s) indicate that the item is not allowed to travel on the determined RUSH flight, an alternative RUSH flight may be determined using the rules (207) specifying preferences for selecting a RUSH flight, in which case the item will be processed to be loaded onto the aircraft of the, new, alternative RUSH flight. If no such security requirement(s) exist or the security requirement(s) are met, the item is processed to the next stage for loading.

Alternatively, such security requirement(s) may be included in the rules (207) specifying preferences for selecting a RUSH flight, in which case a separate step for checking the security requirement(s) after determination of a RUSH flight may not be necessary.

Optionally, the item handling system may be configured to automatically identify one or more causes that lead to the item missing the original departure flight. Such investigation may be performed by investigating timestamped location history of the item, and/or flight information of one or more previous flights on which the item was transported to the origin. This may also enable identification of one or more parties at fault for the mishandling. For example, if the timestamped location history indicates that the item was checked-in later than a recommended latest check-in time, the party at fault would be the passenger. Similarly, if the flight information indicates that the pervious flight arrived at the origin leaving no or little time for the item to be conveyed to the departing point of the original flight, the airline that operated to previous flight may be the party at fault. If the timestamped location history indicates that the item had been stuck on a conveyor system, the operator or proprietor of the conveyor system may be the party at fault.

Consequently, the identified cause of delay (Reasons for Loss) (222) and party at fault (Fault Station) (223) may be saved in the storage means (104) and/or communicated to the passenger and/or the carrier in charge of handling the item.

As shown in FIG. 2, the updated itinerary data including the information relating to the new scheduled route may be forwarded (228) to a global baggage tracing and matching system (102). Based on the updated itinerary data, a mishandled bag report may also be generated (230) and saved in the global baggage tracing and matching system (102).

When the flight information (110) indicates that the passenger has arrived (232) at the destination, the passenger may be notified with details relating to the mishandling of the item and the second itinerary via the global baggage tracing and matching system (102). The details may, for example, include one or more of: notification that the item has missed the original departure flight; notification that the item has been re-routed; an arrival time at the destination based on the second scheduled route; the identified cause of mishandling (Reasons for Loss) (222); and the identified party at fault (Fault Station) (223).

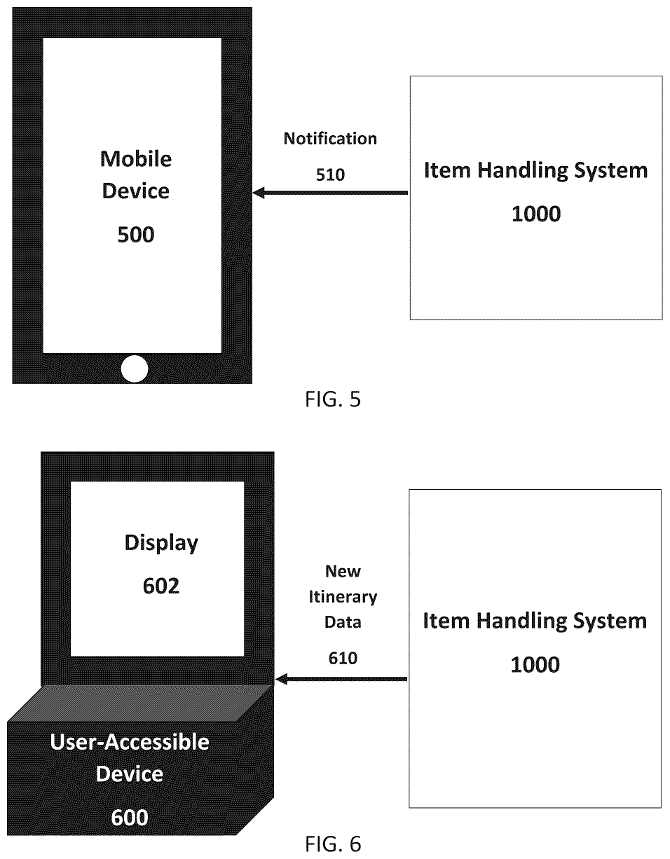

The passenger may be notified with such details by receiving a notification on their mobile (500) device as shown in FIG. 5. Alternatively, or additionally, the passenger may retrieve such details via a user-accessible device or system (600), as shown in FIG. 6, such as an electronic information board or a kiosk located at the destination. Alternatively, or additionally, the notification may be communicated to one or more mobile devices (500) and/or one or more user-accessible devices or systems (600) that are configured to be used by non-passenger users, such as airport and/or airline staff. Optionally, the user-accessible device or system (600) may be an interactive device or system that is accessible to both passenger users and non-passenger users, such as a kiosk.

As the re-routed item typically arrives at the destination later than the passenger, the passenger may prefer the item to be re-routed to a further destination (240), such as their temporary accommodation or home address. Therefore, the global baggage tracing and matching system (102) may create a Baggage Delivery Order (BDO) (236). Optionally, the item handling system may be configured so that such BDO is created only upon request by the passenger. In such cases, the passenger, or a non-passenger user on behalf of the passenger, may request a BDO to be created and, optionally, provide details relating to the further destination (e.g. the passenger's address) via a mobile device or a kiosk.

Communication between two or more components of the item handling system may be performed via one or more wired or/and wireless communication networks. One or more storage devices and/or systems that are part of or connected to the item handling system may be remote storage devices or systems, such as cloud-based storage devices or systems.

The wired or wireless communication networks described above may be public, private, wired or wireless network. The communications network may include one or more of a local area network (LAN), a wide area network (WAN), the Internet, a mobile telephony communication system, or a satellite communication system. The communications network may comprise any suitable infrastructure, including copper cables, optical cables or fibres, routers, firewalls, switches, gateway computers and edge servers.

The system described above may comprise a Graphical User Interface. Embodiments of the invention may include an on-screen graphical user interface. The user interface may be provided, for example, in the form of a widget embedded in a website, as an application for a device, or on a dedicated landing web page. Computer readable program instructions for implementing the graphical user interface may be downloaded to the client device from a computer readable storage medium via a network, for example, the Internet, a local area network (LAN), a wide area network (WAN) and/or a wireless network. The instructions may be stored in a computer readable storage medium within the client device.

As will be appreciated by one of skill in the art, the invention described herein may be embodied in whole or in part as a method, a data processing system, or a computer program product including computer readable instructions. Accordingly, the invention may take the form of an entirely hardware embodiment or an embodiment combining software, hardware and any other suitable approach or apparatus.

The computer readable program instructions may be stored on a non-transitory, tangible computer readable medium. The computer readable storage medium may include one or more of an electronic storage device, a magnetic storage device, an optical storage device, an electromagnetic storage device, a semiconductor storage device, a portable computer disk, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk.

Exemplary embodiments of the invention may be implemented as a circuit board which may include a CPU, a bus, RAM, flash memory, one or more ports for operation of connected I/O apparatus such as printers, display, keypads, sensors and cameras, ROM, a communications sub-system such as a modem, and communications media.

A second aspect of the invention relates to a delayed bag alert system and method for mitigating waiting time and inconvenience associated with mishandled baggage. Specifically, a passenger arriving at the baggage hall has to wait by a baggage carousel whilst all the other bags appear. Any waiting time for the passenger at the carousel is time-consuming and frustrating, which impacts the airline's reputation with the passenger. The passenger must then determine if their baggage will not appear and has been delayed. Once the passenger is seeing no more bags appear (after some time), the passenger must locate a baggage service desk in the airport baggage hall. Sometimes these will be operated by an individual airline, but often they may be a ground handler's baggage desk, servicing multiple airlines, and the passenger will be required to join a queue with passengers from other airlines. In times of disruption, such as weather events or industrial action, the queues may become very long, further frustrating the passenger. Often the passenger will need to locate the correct desk (for a specific airline) and if they choose the wrong desk they may be directed to another desk for the correct airline. Once the passenger has reached the front of the queue, they will be required to provide details on their delayed baggage including, their flight details, their baggage details including a description of the colour, type and design, their address details, and a customs declaration to clear the baggage for delivery back to the passenger. This is often conducted in English or a local language which may not be the passenger's first language. This slows down the interaction and may lead to errors in the details.

The inconvenience associated with this may be removed by:
1) tracking the bag's journey and automatically reacting if the baggage has been mishandled;
2) automatically creating a delayed bag file in the background, and automatically adding accurate and pertinent information to assist with the repatriation of the delayed baggage;
3) automatically notifying the passenger as they step off the aircraft, at their final destination, and informing the passenger their baggage has been delayed; and
4) directing the passenger to self service (e.g. self-service kiosk, website, or mobile app), where the report has already been completed, and requesting the passenger to append the report with delivery and customs info, all in the passenger's local language.

In addition, if the system can retrieve information relating to the current or estimated location of the bag (such as being reflighted on a later flight to the passenger's destination), the system can inform the passenger of their bag's current location and estimated arrival time, to help reduce any passenger anxiety associated with the baggage delay.

The system provides several benefits to both passengers and airlines. For example, the passenger may no longer be required to stand at the baggage carousel for long periods of time, waiting for their baggage to appear, then locate the correct baggage service desk, queue up, and report their delayed baggage to an agent (often in another language). Instead, the passenger may receive a notification on arrival at their final destination directing them to self-service, and, optionally, informing the passenger of when their baggage may arrive so the passenger can plan accordingly. Optionally, the passenger may be given an option to complete a simple report, preferably in their own or a preferred language. Therefore, the system advantageously allows the passenger to skip the baggage carousel, queues and service desks, and go straight to their destination, thereby significantly improving passenger experience with the airline and/or the airport.

Using such a system is advantageous for the airlines, as implementing and using the system would not require specialist equipment or internal development. This reduces the upfront cost and also reduces the time required to “go live” with the notification system, and provides a system with functionality to track the bag across multiple airlines. The system may also enable delayed bag file to be created automatically. The automated process may also allow airlines and/or ground handlers to focus their resources on other matters, reducing both queues and service desks in the baggage hall. Furthermore, the improved passenger experience leads to an improved airline reputation and repeat passenger business. Thus, the system provides improved passenger experience, reduces agent workload and is cost-effective.

The delayed bag alert system may utilise a number of existing services which operate in stages in order to successfully notify the passenger in case their baggage is delayed. Optionally, the delayed bag alert system may, for example, be delivered by using an existing baggage message distribution system (e.g. SITA Bag Message available from SITA), a baggage data repository (e.g. SITA Bag Journey available from SITA), baggage repatriation tools (e.g. WorldTracer® available from SITA), flight tracking tools (e.g. SITA FLIFO available from SITA), and/or DCS integration tools (e.g. SITA DCS Integration available from SITA).

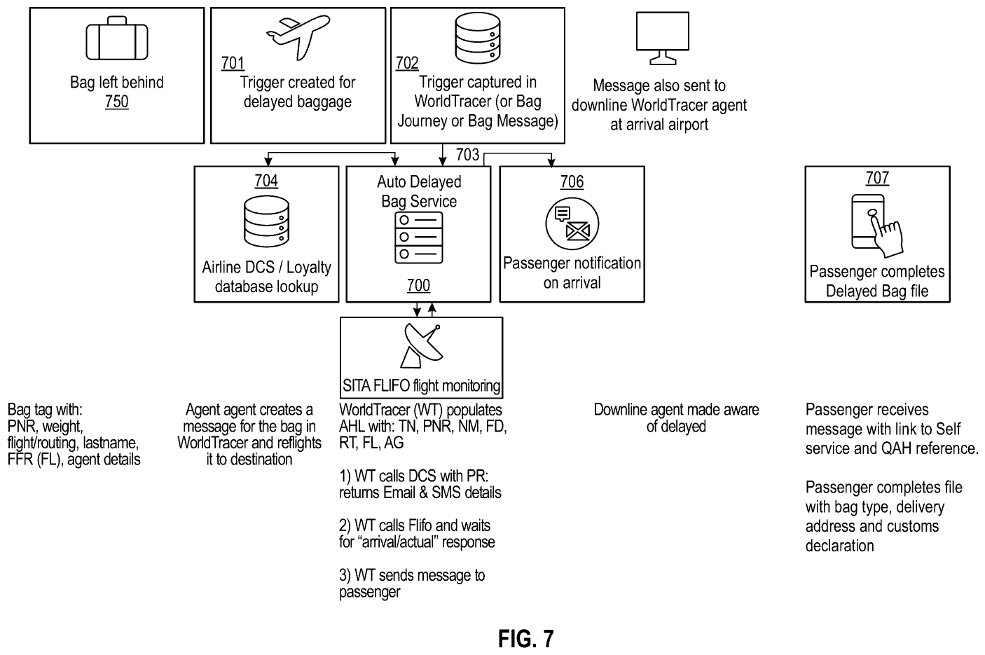

FIG. 7 illustrates an exemplary process flow in an exemplary delayed bag alert system comprising an auto delayed bag service module (700). As shown in FIG. 7, when a bag is delayed (750), the auto delayed bag service module (700) may be activated with a trigger (701) from a discrete set of sources which may come from an industry system for managing mishandled baggage (e.g. SITA WorldTracer®), a repository of baggage events (e.g. SITA Bag Journey) and/or a messaging service for baggage sortation (e.g. SITA Bag Message). The trigger may optionally be in the form of a Baggage Source Message (BSM) or Baggage Processing Message (BPM) or Type B/X message or internal message in A baggage repatriation tool (e.g. WorldTracer®). The system may capture (702) and collect (703) these messages and then identify the unique baggage tag associated with the event or trigger.

Once activated, an auto delayed bag service module (700) may identify the airline and connect to the airline departure control system (DCS) and/or Loyalty Database (704) to collect passenger, flight and baggage information associated with the baggage tag. The passenger information may be stored across multiple sections of the DCS or Loyalty database (704), therefore, some logic may be applied in order to identify the most accurate contact information.

Optionally, the information may be temporarily stored in the system. Optionally, a set of business rules may be applied to ensure the passenger is only notified if certain requirements are met. Optionally, the flight routing may be analysed to identify the final leg or segment where the passenger would expect to collect their baggage.

The service module (700) may then track (705) the final flight to identify when the flight has arrived.

On arrival, the system may automatically compile a delayed baggage report. Optionally, multiple bags may be grouped into a single report. A notification to the passenger is then sent (706) to inform them of the delay.

After receiving the notification, the passenger may navigate to self-service to provide (707) further information, such as delivery address and customs declaration. From self-service, the passenger may then follow the progress of their delayed baggage.

In addition, data may be collected and an airline reporting tool may be available for airline agents and management to track success of the service.

Thus, in the exemplary system shown in FIG. 7, the system may be operated following the steps of:

Step 1) The auto delayed bag service module (700) is triggered (701) by an event (750) connected to a mishandled baggage;

Step 2) The auto delayed bag service module (700) collects (703) information from the trigger, and connects to the airline's DCS and/or loyalty database (704) to collect further information on:
a. The passenger details, including names, contact information and passenger status;
b. The flight and routing details which may cover all or part of all flight legs and/or segments associated with the trip; and
c. The baggage details, including baggage tracker details (e.g. bag tag number or baggage file reference) and, optionally, baggage weight and/or sizes;

Step 3) The auto delayed bag service module (700) may optionally apply a set of business rules to process the next step. These business rules may include information relating to one or more of:
a. If the trigger is trusted source
b. Whether there is suitable contact information for the passenger.
   i. The auto delayed bag service module (700) provides a hierarchy structure to all the contact information to ensure the most accurate contact information is used.
   ii. The auto delayed bag service module (700) also cleans up contact information (such as phone number format or email address structure)
   iii. The auto delayed bag service module (700) also checks if the passenger has “opted out” of receiving updates (and whether this may be overruled by the airline)
c. The destination of the passenger and where they may expect to collect their baggage
d. If the trigger is valid (in some cases, if a certain threshold is reached, the trigger may be ignored)
e. If the airport the passenger has departed from or arriving at is ‘activated’ for automatic notification by the airline
f. If the baggage is a certain type (such as passenger mobility aids) to notify other sources
g. If the passenger has a certain loyalty status, or travelling in a certain airline cabin, to notify other sources
h. Whether multiple bags may be grouped into a single delayed baggage file or split into several delayed baggage files
i. If the flight has recently arrived or if the passenger has already reported the bag as delayed;

Step 4) The auto delayed bag service module (700) identifies the passenger's final flight based on routing information and, optionally, one or more business rules, and follows the live progress of the flight (this can be done using SITA FLIFO data or other real-time flight data sources (814));

Step 5) Once the flight data source has confirmed the flight has landed or arrived, optionally, a timer may be set to allow suitable time for taxiing to gate and passengers to leave the airplane. This is to prevent notifying the passenger whilst they are still onboard the aircraft which could present a problem for cabin staff;

Step 6) At the same time as, or shortly after, the aircraft has landed or arrived, optionally, all or at least some of the delayed baggage tags may be grouped, depending on airline rules, into delayed baggage files in a baggage repatriation tool (e.g. WorldTracer®). The data in the system may be used to pre-fill information on one or more of: the passenger, baggage, and flight and routing in the delayed baggage file;

Step 7) Upon or shortly after the aircraft has landed or arrive at the destination airport, or once the timer has expired (if the optional timer was used), the auto delayed bag service module (700) uses the contact information for the passenger to send a message to the passenger. This may be sent by one or more of: email, SMS, WhatsApp, Apple Business Chat, Line, Weibo/Wechat and other notification service. A message may also be generated to the airline's own passenger system to send a notification via the airline's own native mobile app to the passenger. Alternatively, the message may be sent to the destination airport or the airline to enable the passenger to be notified via other notification device(s), system(s), or method(s), such as a self-service kiosk or an electronic information board located at the airport;

Step 8) The message to the passenger contains details of the delayed baggage file and, optionally, a link to a self service website. The message may, optionally, also include the location and reflighting information of the delayed bag if available;

Step 9) If the message contains a link to a self service website, the passenger may seamlessly navigate to the self service website where they are able to check the flight and baggage information, add in delivery information for the delayed baggage and make a customs declaration. Alternatively, this may be performed using other device(s), system(s), or method(s), such as a self-service kiosk located at the airport;

Step 10) At the same time, optionally, the airline may also be notified that the auto delayed bag service module (700) has processed a mishandled bag, and can take appropriate action if required. For example, the delayed item may be associated with a passenger required mobility assistance, or if a premium passenger may require further care;

Step 11) The auto delayed bag service module (700) can, optionally, also support multiple carriers on a multi-leg or multi-segment trip, where the passenger travels with both Airline A and Airline B. For example, if the bag is delayed by Airline A on departure, the auto delayed bag service module (700) may automatically transition to Airline B to notify the passenger at their destination and direct passenger to Airline B's self service;

Step 12) The auto delayed bag service module (700) may, optionally, also analyse the trip (outbound and return) to identify if a bag should be held in case of a short trip;

Step 13) The passenger may, optionally, also elect to wait for their baggage in the airport where the baggage is only delayed by a few hours; and

Step 14) The operational data may, optionally, be stored for each event, which can be used for a reporting service which may be available for airline agents and management to track progress and report on success of the service.

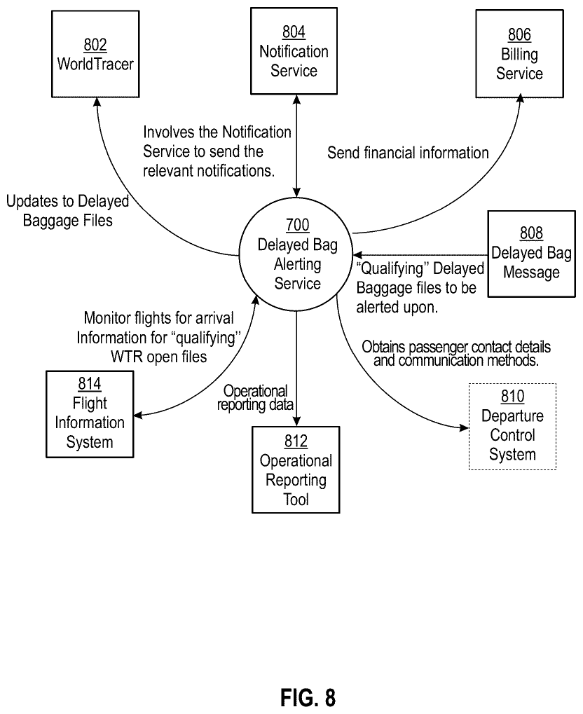

FIG. 8 illustrates interactions between an exemplary delayed bag alert service module (700) and other module(s) and/or system(s). As shown in FIG. 8, the delayed bag alert service module (700) may be connected to one or more module(s) and/or system(s). The delayed bag alert service module (700) may, for example, be connected to one or more of:
Mishandled baggage management application (802), such as WorldTracer, for creating delayed baggage files, matching with passengers and delayed baggage, and managing the reflighting of delayed baggage back to the passenger;
A notification service (804), which may use SITA Communications Platform to build branded & customised messages, and send the messages to the passenger by email, SMS, WhatsApp, Apple Business Chat, Facebook Messenger, Line, Weibo/Wechat and other social media channels;
A billing service (806), for tracking usage and sending usage data to the billing organisation in SITA;
A connection (808) to airport baggage handling systems (via Bag Message), baggage conciliation services (like SITA Bag Manager) and baggage tracking applications (such as SITA Bag Journey) for capturing events indicating a bag is mishandled;
An airline departure control system (DCS) and/or Loyalty Database (810) for collect information on the passenger (including contact information), baggage and flights & routing;
An operational reporting tool (812) for storing operational data and providing the ability to run standard reports on performance of the system (for management reporting). Ability to export data to a reporting system (such as Cognos or PowerBI available from Microsoft); and
Connection to a flight information system (814), such as SITA FLIFO and SITA AIMS to track flight status in real time.

The abovementioned Step 1 of triggering (701) the auto delayed bag service module (700) may be activated by retrieving one or more messages or activities from the mishandled baggage management application (802), such as WorldTracer. For example, the messages or activities may be one or more of:
A “forward” (FWD) message, where the delayed bag is being reflighted;
An “on-hand” message, where a baggage tag has been reported as found/left behind but not yet matched to a passenger; and
A “quick on-hand” message, as above, but in a simpler format.

Alternatively, the abovementioned Step 1 of triggering (701) the auto delayed bag service module (700) may be activated by receiving one or more baggage messages (e.g. BSMs and/or BPMs) containing details of the delayed bag. Such one or more messages may be received via the connection (808) to airport baggage handling systems (via Bag Message), baggage conciliation services (like SITA Bag Manager) and baggage tracking applications (such as SITA Bag Journey) for capturing events indicating the bag is mishandled. Such one or more messages may, for example, indicate that the bag is or is believed to be a missed or RUSH baggage (e.g. message(s) having .E/ missed or .E/ rush element; message(s) having .R/rush or R /missed element; and Bag Not Seen (BNS) message(s) from Bag Journey).

Optionally, the auto delayed bag service module (700) may be configured so that a trigger (701) for delayed baggage is only created when one or more additional rules are met. For example, the trigger (701) may be created only if the baggage is handled by specific airline(s) (e.g. customer airline(s)) and/or if the baggage is handled at specific departing and/or arriving airport(s). Optionally, the additional rules may specify the trigger (701) is not created if the baggage is handled by specific excluded airline(s) and/or if the baggage is handled at specific excluded departing and/or arriving airport(s).

Optionally, the additional rules may specify that the trigger (701) is created only if one or more received or retrieved bag massages are of one or more of type(s) of the message(s) specified in the additional rule. For example, the additional rules may specify that the trigger (701) is created only if one or more received or retrieved bag massages are one or more of: FWD, BPM (with .E element or with OND on-hand element), “on-hand” message(s), and “bag-not-seen” message(s). Optionally, the additional rules may specify that any type of message(s) received for a specific station and/or the carrier will create a notification.

Optionally, the additional rules may specify that the trigger (701) is created only if one or more received or retrieved bag massages are from one or more of source(s) specified in the additional rule. For example, the additional rules may specify that the trigger (701) is created only if one or more received or retrieved bag massages are from one or more of: A baggage repatriation tool (e.g. WorldTracer®); an airport baggage reconciliation system (BRS) such as Bag Manager, Zafire, Brock; an airport baggage handling system (BHS); and an airline's own system (e.g. by web services, Type A, Type B or Type X message).

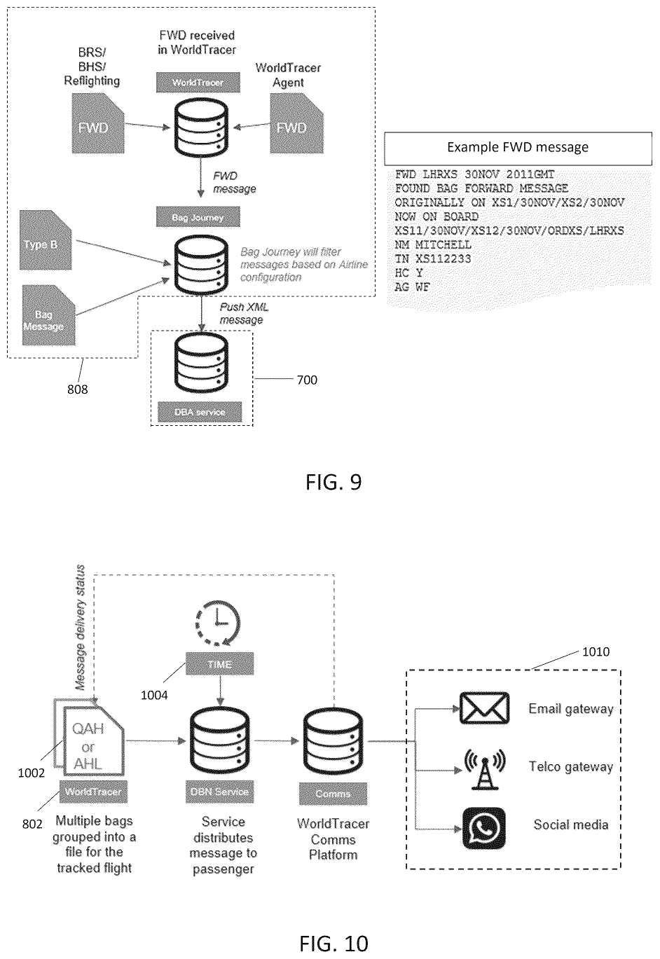

Such additional rules may optionally be configured by a user (e.g. an airline that is in charge of transporting the baggage) and may optionally be implemented as a filter. FIG. 9 is a schematic diagram of an exemplary trigger design (left), and an example FORWARD (FWD) message (right) that may be used in the step of triggering (701) the auto delayed bag service module (700). In the example shown in FIG. 9, one or more FWD messages, including baggage information, are received in The baggage repatriation tool (e.g. WorldTracer®). The baggage information included in each of the FWD message(s) may comprise a baggage identifier (e.g. baggage tag number), baggage status (e.g. lost, found, or RUSH), and details relating to baggage journey (e.g. original and new flight details). The FWD message(s) may then be sent to a baggage tracking application (e.g. Bag Journey) which will filter the FWD message(s) depending on the additional rules. The FWD message(s) that meet the requirement(s) specified in the additional rules are sent (e.g. in XML message format) to the auto delayed bag service module (700). This enables the auto delayed bag service module (700) to collect (703) information from the message(s), and connect to the airline's DCS and/or loyalty database (704) to collect further information on the corresponding baggage(s), passenger(s), and/or flight(s).

Referring to the abovementioned Step 2 and FIGS. 7 and 8, the auto delayed bag service module (700) may connects to the airline's DCS and/or loyalty database (704) and retrieve further information of the baggage(s), passenger(s), and/or flight(s) that correspond to the information (e.g. the baggage tag number, PNR, passenger ticket number or other identifying details) collected (703) from the message(s). Such further information may, for example, comprise one or more of: PNR(s); full flights/dates/routing details; contact information (email and/or SMS); class of service and passenger status; and frequent flyer number.

In cases that the frequent flyer reference from the airline's DCS and/or loyalty database (704) is retrieved, the auto delayed bag service module (700) may make a web service call to the airline's loyalty database to collect further contact information and the passenger's home address to ensure higher success rate for message contact and to offer pre-population of the passenger's home address.

Referring to the abovementioned Step 3, the auto delayed bag service module (700) may apply a set of business rules specifying a hierarchy to sort and/or identify the most pertinent contact information (e.g. email, telephone and/or mobile number) of the corresponding passenger(s). Such business rules may be stored in the auto delayed bag service module (700) or other component of the system connected to the auto delayed bag service module (700).

Optionally, the business rules may further include rule(s) for checking if the passenger has provided preference regarding if they do not wish to be contact by the identified contact information (i.e. opt-out). If the passenger has opted-out, the business rules may optionally include rule(s) for checking if the airline has configured to override the passenger's preference.

Optionally, the business rules may further include rule(s) for checking the quality of the identified contact information (e.g. email, telephone and/or mobile number). Optionally, the business rules may further include rule(s) for converting the identified contact information into suitable format(s) that can be directly used for contacting the passenger. For example, telephone and/or mobile number(s) may be converted into a specific format, such as +(country code) (local number without a leading zero) as shown in the following examples:
44-07700-123456 to +447700123456
(UK) 07700123456 to +447700123456
(USA)+1-617-222-5555 to +16172225555

Optionally, if an identified telephone or mobile number does not have a country code, a country code that is most likely to be the correct country code is used. The most likely to be the correct country may be determined based on one or more of the passenger details (e.g. nationality and residency) and the journey details (e.g. country of arrival and departure).

Optionally, such conversions may be performed by using public phone number clean up data libraries (e.g. Google phone number clean up library) and/or a custom-built logic (e.g. SITA logic).

Similarly, email address(es) may optionally be converted to correct errors found in the email address(es). For example, special character(s) in email address(es), except for “@”, may be removed from the email address(es) as shown in the following examples:
jfp***travelagent***@gmail.com to jfp@gmail.com
jfp+123@me.com to jfp123@me.com
jfp&123@outlook.com to jfp123@outlook.com

Optionally, the business rules may further include rule(s) for checking if multiple mishandled items can be grouped into a single group (pooled baggage) to process the mishandled items more efficiently. For example, if a family travelling together has three checked bags, but two are mishandled, the system may group the two mishandled bags into a single mishandled baggage file to enable more efficient administration for both the airline and passenger. In such cases, the business rule may optionally identify the best contact details to use to contact passengers in a same group (e.g. a family travelling together). For example, the business rule may optionally identify contact details of a lead passenger of a group of passengers as the contact details to be used to contact the group of passengers. In cases that the contact details of the lead passenger cannot be identified, or if, according to the business rules, it is determined that the contact details of the lead passenger should not be used to contact the group of passengers the business rules, contact details of one or more other passengers of the same group may be used to contact the group of passengers.

Referring to the abovementioned Step 4, the auto delayed bag service module (700) may check where the baggage is “checked to” in the DCS (810) record, in order to identify at which location (e.g. at which airport) the passenger will expect to go to the baggage claim, and therefore notify the passenger at the location. For this, firstly, the auto delayed bag service module (700) may identify the “checked to” location in the DCS (810) record. Then, secondly, the auto delayed bag service module (700) may also apply a logic using flight routing lookup and, optionally, by taking into account one or more business rules and/or one or more requirements by a local authority, airport, or airline, in order to identify at which location (e.g. at which airport) the passenger will expect to go to the baggage claim. For example, flight routing for a passenger travelling from LHR to LAX via JFK, would include two legs and/or segments:
Flight XS1 (LHR to JFK); and
Flight XS2 (JFK to LAX).

In this example, although the passenger's bag appears to be checked to LAX, as the local authority in the US requires passenger arriving in the US on international flights to collect baggage at their first arrival airport in the US, it will be useful for the passenger to receive a notification notifying that their checked bag is delayed at the first airport of international arrival (JFK in this example).

Therefore, the auto delayed bag service module (700) may use airline flight tables (e.g. SITA FLIFO) to query XS1 and XS2 to identify the airports associated with the flight routing, and determine if any flight of the flight routing is within the same country (domestic) or between different countries (international). If any international flight (XS1, LHR to JFK in this example) is identified and if the local authority, airport, and/or airline require the passenger to collect their baggage at their international arrival airport, and the passenger is alerted on arrival after the international flight (JFK in this example).

Referring to the abovementioned Steps 4 and 5, the auto delayed bag service module (700) may use (705) one or more real-time data sources (e.g. industry data sources such as SITA FLIFO, SITA AIMS, FlightRadar, FlightAware, ADS-B data, ACARS data, and transponder data) (814) to track the final flight or other flight in the passenger's route after which the passenger is scheduled to receive a delayed bag notification, capture various event, and take action based on certain events. For example, corresponding events may be captured to determine the current status and/or estimated location of the flight by retrieving event codes associated with the flight from the real-time data sources (814). Event codes that may be particularly important may include: AD (arrived-diverted), AP (approach), AR (arrived), LD (landed diverted), LN (landed), LR (landed recovered), OG (landed—on ground), and RA (arrived-recovered), which are event codes used widely known and used in the aviation industry.

Referring to the abovementioned Step 6 and FIG. 10, the auto delayed bag service module (700) may automatically generate a delayed baggage data (1002) in mishandled baggage management application (802), such as WorldTracer® based on check-in data and baggage pool data (outlined in step 3). Such data (1002) may be generated in a file format, such as a “full” baggage file (e.g. a WorldTracer® AHL) or a “light” baggage file (e.g. a WorldTracer® “QAH”).

Referring to the abovementioned Steps 6 and 7, and FIG. 10, the auto delayed bag service module (700) may apply a timer (1004) after the arrival of the flight in order to ensure that the passenger has left the aircraft before receiving a notification of the baggage delay. This is to prevent notifying the passenger whilst they are still onboard the aircraft which could present a problem for cabin staff. Such a timer (1004) may be configured by each airline or airport, or have a pre-determined default value (e.g. 30 mins after arrival). Optionally, the timer may start upon arrival of the aircraft at the airport. In such cases, the arrival may correspond to the time of landing of the aircraft at the airport, which may be determined from live flight status data (e.g. Actual Landing Time (ALDT) of the aircraft according to flight information (e.g. SITA FLIFO)). Alternatively, where live flight status relating to the time of landing is not available, the time of landing of the aircraft at the airport may be determined from estimated flight status data (e.g. Estimated Landing Time (ELDT) of the aircraft according to flight information (e.g. SITA FLIFO)). Another alternative or live location of the aircraft (e.g. GPS data). Optionally, the timer (1004) may be configured to have a time value determined based on historical data of landing time and deboarding time. For example, the timer (1004) may be configured to have a value that is equal or larger than an average duration between landing and completion of boarding at the airport. Optionally, one or more of other factors, such as time of landing, weather condition, gate availability, taxiway traffic, and distance between the corresponding runway and the gate may be further taken into account when determining the time value. Optionally, one or more machine learning techniques may be used to determine the time value based on the historical data of landing time and deboarding time, and/or the one or more of other factors.

Alternatively, the auto delayed bag service module (700) may determine that the passenger has left the aircraft based on the location of the passenger. In such cases, the passenger may receive the notification of the baggage delay when or after leaving the aircraft. The location of the passenger may, for example, be determined by performing image recognition based on a camera feed from a camera at a known location, detecting a locating of a mobile device held by the passenger (e.g. using Bluetooth, Wi-fi, cellular, GPS location tracking), and/or live flight status confirming completion of deboarding or gate arrival.

Referring to the abovementioned Step 8, and FIG. 10, once the timer (1004) has expired and/or it is determined that the passenger has left the aircraft, the message to the passenger can be sent by one or more communication channels (1010), such as email, SMS, social media and/or other communication methods such as WhatsApp and WeChat. Optionally, the one or more communication channels may be selected by the airline.

Optionally, the notification may provide access to a chatbot (e.g. on SMS and/or social media), so that the passenger may respond to the received notification with any questions, and receive answers to the frequently asked questions from the chatbot. This helps ensure the passenger understands the repatriation process and reduces inbound calls to the airline's contact centre.

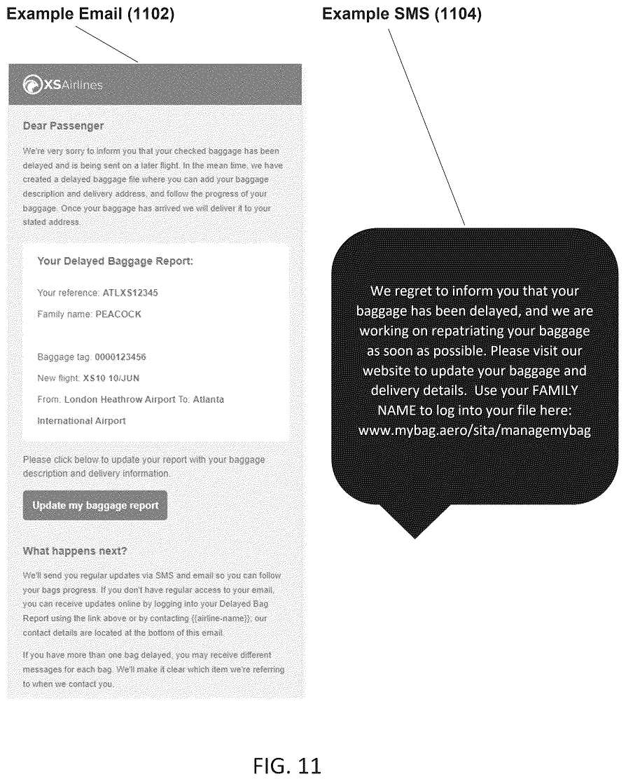

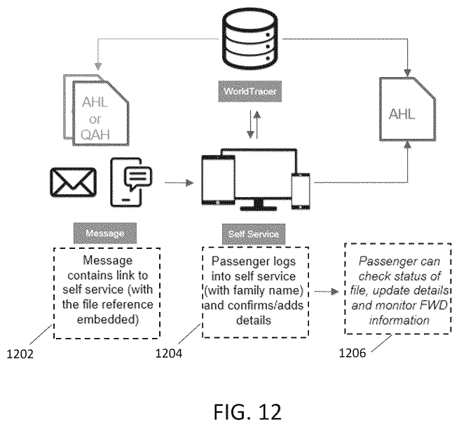

FIG. 11 show an exemplary email notification (left) (1102) and an exemplary SMS notification (right) (1104). As shown in FIG. 11, such a message (1102, 1104) may comprise (1202) details of the delayed baggage (e.g. baggage tag number) and/or a hyperlink and relevant instructions (e.g. login credentials to be used) (1204) to access a website or an app via which such delayed baggage details may be accessed. Optionally, a reference to the baggage data (e.g. a baggage file) may be embedded in the hyperlink. Optionally, the website or the app may enable modification of details associated with the delayed baggage. The message (1102, 1104) may also contain information to direct (1202) the passenger to self-service. The self-service may be accessed by the passenger on an electronic device such as a mobile device, a computer, and/or a kiosk located in the arrival airport. This enables the passenger to provide any missing information, such as a delivery address and customs declaration). Based on the information provided, the baggage date (e.g. baggage file) is then updated, and the passenger can follow (1206) the delayed bag's progress by checking the website and/or the app. FIG. 12 shows an exemplary process of using the self-service. In the example shown in FIG. 12, the passenger receives (1202) a message (1102, 1104) containing a hyperlink to the self-service and a baggage tracking reference (e.g. baggage file reference). The passenger can then access the self-service by following the hyperlink. The self-service may request further information such as the passenger's details (e.g. their name(s) and/or address) for identification or addition to the baggage file. The self-service may enable the passenger to check (1206) the status of the baggage file and/or update details included in the baggage file.

Optionally, the system can generate a real-time push notification (XML feed) with baggage and passenger information to the airline's own system. This enables the passenger to receive the notification and updates using the airline's mobile app and/or website.

Referring to the abovementioned Step 8, the auto delayed bag service module (700) may automatically generate messages within the mishandled baggage management application (802), such as WorldTracer®, to inform agents of activities and if they need to take action. The messages may be sent to the “downline agent” at the arrival airport.

Table 1 lists examples of messages that may be generated.

TABLE 1
Table of exemplary messages generated within the management application (802)

| Message | Description | Note |
|---|---|---|
| Initial file | Auto generated | Likely contains only a single |
| creation message | on trigger | bag tag. Generated as soon |
| | | as a delayed bag is |
| | | identified |
| Consolidated file | Flight has arrived, delayed | Multiple delayed bags |
| creation message | bags consolidated, | grouped into a single |
| | notification sent to | file for the passenger |
| | passenger | |
| No passenger | Delayed baggage file | No contact information in the |
| contact details | is generated but the | DCS/Loyalty DB, contact |
| | passenger could not | information could not be |
| | be notified | parsed, or message delivery |
| | | failed |
| Baggage agent | Message sent to passenger | May be used where the |
| notification | but no file created | passenger is travelling |
| | | with multiple airlines. |
| | | Final operating airline |
| | | has responsibility |
| | | for creating file |
| Mobility item | If a delayed bag trigger | Extra care required by |
| message (PRM) | contains a mobility item | the airline to support |
| | | passengers with reduced |
| | | mobility (PRM) |
| VIP passenger | If the passenger is travelling | Extra care required by the |
| | in a particular airline cabin | airline to support the |
| | (e.g. First) or has a certain | passenger. |
| | status with the airline | |

Referring to the abovementioned Step 11, the passenger may travel on a route comprising flight services operated by multiple carriers. In such cases, the passenger's checked bag may be mishandled by a first carrier, but the passenger may arrive at their destination on a second carrier, as shown in the example routing below:

### Example Routing

Airline 1 from SFO to JFK (airline code XS) SFO XS→JFK XS
   Passenger baggage mishandled by Airline 1
Passenger transfers from XS to MM at JFK
Airline 2 from JFK to LHR (airline code MM) JFK MM→LHR MM

In such cases, the message (1102, 1104) may be sent to the passenger at one or more stages of the journey. A first option is to send the message (1102, 1104) to the passenger whilst the passenger is at the arrival airport (JFK in the current example) of the first leg (SFO XS→JFK XS in the current example) of the journey. The message (1102, 1104) may optionally direct the passenger to the first airline's (Airline 1's) service desk or a self-service (e.g. self-service kiosk, website, or mobile app) to transfer baggage tracking information of the mishandled baggage to the second airline (Airline 2). Optionally, the message (1102, 1104) may optionally comprise a link to a website or a mobile app on which the passenger can request or authorise that the baggage tracking information of the mishandled baggage be transferred from the first airline to the second airline for further handling. Optionally, such transfer of baggage tracking information from the first airline to the second airline may be performed automatically without requiring a request or authorisation by the passenger. Alternatively, the baggage tracking information may be shared between the first airline and the second airline on a common baggage tracing and matching system (e.g. SITA WoldTracer). Optionally, the message (1102, 1104) may direct (1202) the passenger to a self-service for baggage recovery (e.g. SITA WorldTracer Self-Service) that enables the passenger to report the mishandling, track the mishandled baggage, and/or request delivery of the mishandled bag to a further destination (e.g. the passenger's preferred delivery address).

A second option is to send the message (1102, 1104) to the passenger whilst the passenger is at the final arrival airport (LHR) of the journey. The message (1102, 1104) may optionally direct the passenger to the first airline's (Airline 1's) service desk or a self-service (e.g. self-service kiosk, website, or mobile app) to transfer baggage tracking information of the mishandled baggage to the second airline (Airline 2). Optionally, the message (1102, 1104) may optionally comprise a link to a website or a mobile app on which the passenger can request or authorise that the baggage tracking information of the mishandled baggage be transferred from the first airline to the second airline for further handling. Optionally, such transfer of baggage tracking information from the first airline to the second airline may be performed automatically without requiring a request or authorisation by the passenger. Alternatively, the baggage tracking information may be shared between the first airline and the second airline on a common baggage tracing and matching system (e.g. SITA WoldTracer). Optionally, the message (1102, 1104) may direct (1202) the passenger to a self-service for baggage recovery (e.g. SITA WorldTracer Self-Service) that enables the passenger to report the mishandling, track the mishandled baggage, and/or request delivery of the mishandled bag to a further destination (e.g. the passenger's preferred delivery address).

Optionally, the message (1102, 1104) may be sent to the passenger at multiple stages of the journey. In such cases, the messages (1102, 1104) received at different stages of the journey may include updated information.

Optionally, if the passenger opted-out of receiving delayed or mishandled bag notifications (1102, 1104) on the passenger's mobile device, the notification service (804) may send no delayed or mishandled bag notification (1102, 1104) to the passenger's mobile device.

Optionally, the notification service (804) may send the delayed or mishandled bag notification (1102, 1104) to a lead passenger accompanying the passenger.

The embodiments discussed above relate to examples of the passenger arriving earlier at the destination than one or more of the passenger's items. However, in other embodiments, the passenger may arrive later at the destination than one or more of the passenger's items. In such cases, the delayed baggage alert system and method may be used to send a notification to the passenger to alert that the one or more of the passenger's items have arrived and/or will arrive at the destination earlier than the passenger's arrival time at the destination. Such a message may be sent to the passenger upon or after the passenger's arrival at the destination. Alternatively, such a message may be sent to the passenger prior to the passenger's arrival at the destination (e.g. whilst the passenger is at the origin or at an intermediate points of the journey if the journey involves multiple legs and/or segments).

The term “processor” or “processing means” as used herein means one or more processing devices, apparatus, programs, circuits, components, systems and subsystems, whether implemented in hardware, software or both, and whether or not programmable. The term “processor” or “processing means” as used herein includes, but is not limited to one or more computers, hardwired circuits, signal modifying devices and systems, devices and machines for controlling systems, central processing units, programmable devices and systems, field programmable gate arrays, application specific integrated circuits, systems on a chip, systems comprised of discrete elements and/or circuits, state machines, virtual machines, data processors, processing facilities and combinations of any of the foregoing.

The terms “storage”, “storage means”, “storage medium” or “data storage” as used herein mean one or more data storage devices, apparatus, programs, circuits, components, systems, subsystems and storage media serving to retain data, whether on a temporary or permanent basis, and to provide such retained data.

The term “tracker” or “tracking means” as used herein means one or more tracking devices, apparatus, tags, labels, or barcodes, which may be associated with, coupled to, and/or attached to one or more items, such as a bag or baggage. The “tracker” or “tracking means” may utilise one or more tracking technologies, such as Radio Frequency Identification (RFID), Radio Tracking, Near-Field Communication (NFC), Geofencing, Internet Tracking, Cellphone Triangulation, Global Positioning Systems (GPS) & Satellite Tracking, Efficient Tracking Solutions with Geoforce, computer vision technique, barcode, QR code, and/or optical character reading (OCR).

1. A system for notifying a delayed arrival of an item at a destination, wherein, according to an original schedule, the item and a passenger associated with the item are scheduled travel from an origin and arrive at a destination at an original scheduled arrival time, the system comprising:
a. a processor configured to:
i. retrieve delayed item data indicating that the item will arrive at the destination later than the passenger; and
ii. send a first notification to a mobile and/or a user-accessible device that is/are accessible by the user, the notification informing that the item and the passenger will arrive at different arrival times at the destination.

2. The system of claim 1, wherein the delayed item data is retrieved from a database comprising data of one or more mishandled items at the origin, wherein the item is one of the one or more mishandled items.

3. The system of claim 1, wherein the delayed item data is retrieved via a message sent to the system comprising an event log indicating mishandling of the item.

4. The system of claim 1, wherein the notification is sent when the processor determines that one or more predetermined conditions are met, and preferably wherein at least one of the one or more predetermined conditions relate to a location of an aircraft, train or a vessel transporting the passenger, and/or a location of the passenger, and the notification is sent upon or after the passenger exits an aircraft, train, or a vessel transporting the passenger.

5. The system of claim 4, wherein the notification is sent upon or after the aircraft, train or vessel arrives at the destination, preferably wherein the location of the aircraft, train or a vessel is determined from a real-time database, preferably wherein the real-time database is a flight information database (FLIFO), or live train or vessel departure and arrival database.

6. The system of claim 4, wherein the notification is sent upon or after the passenger exits an aircraft train, or vessel transporting the passenger, preferably wherein the location of the aircraft, train or a vessel, and/or the passenger is determined from a real-time database, preferably wherein the real-time database is a flight information database (FLIFO), or live train or vessel departure and arrival database, and preferably wherein the location of the passenger is determined from location data retrieved from a mobile device associated with the passenger.

7. The system of claim 4, wherein the notification is sent upon or after the passenger arrives at an item collection point at the destination, preferably wherein the location of the passenger is determined from location data retrieved from a mobile device associated with the passenger, preferably wherein the item collection point is a baggage carousel.

8. The system of claim 1, wherein the processor is configured to retrieve passenger data prior to sending the notification.

9. The system of claim 8, wherein at least a part of the notification is in a language preferred by the passenger, wherein the language is a user-specified preferred language included in the passenger data, or an official language of a country of the user's nationality or residency according to the passenger data.

10. The system of claim 8, wherein the passenger data comprises at least one of: a mobile number, user email, and, app or website account associated with the passenger, and the notification is sent to the mobile device associated with at least one of: the mobile number, user email, and, app or website account associated with the passenger.

11. The system of claim 8, wherein if the passenger data does not comprise at least one of: a mobile number, user email, the notification is sent to the passenger-accessible device, preferably wherein the passenger-accessible device is a kiosk or an electronic board.

12. The system of claim 1, wherein the processor is configured to:
iii. retrieve a new scheduled arrival time for the item to arrive at the destination, the new scheduled arrival time being later than the original scheduled arrival time.

13. The system of claim 1, wherein the processor is configured to send the first notification to the mobile and/or the user-accessible device that is/are accessible by the user, the notification informing that the item will arrive at the destination later than the passenger.

14. The system of claim 1, wherein the processor is configured to send the first notification to the mobile and/or the user-accessible device that is/are accessible by the user, the notification informing that the item arrived at the destination earlier than the passenger.

15. The system of claim 12, wherein the first notification further comprises information relating to the new scheduled arrival time for the item to arrive at the destination.

16. The system of claim 12, wherein the processor is configured to:
iv. send a second notification to the mobile and/or the user-accessible device that is/are accessible by the user, the second notification comprising information relating to the new scheduled arrival time for the item to arrive at the destination.

17. The system of claim 1, wherein the processor is configured to:
v. receive a further destination information, comprising an address to which the item to be transported from the destination, from the user via the mobile and/or the user-accessible device that is/are accessible by the user.

18. The system of claim 15, wherein the first and/or second notifications further comprises information relating to a scheduled arrival time for the item to arrive at the further destination.

19. The system of claim 15, wherein the processor is configured to:
V. send a third notification to the mobile and/or the user-accessible device that is/are accessible by the user, the third notification comprising information relating to the new scheduled arrival time for the item to arrive at the further destination.

20. The system of claim 1, further comprising an item handling system for moving an item between an origin and a destination according to a first scheduled route which departs the origin at a first predetermined departure time, wherein the system comprises:
b. a processor configured to:
i. determine whether the item has missed the first predetermined departure time of the first scheduled route;
ii. determine the destination for the item;
iii. determine a new, second, scheduled route between the origin and the determined destination wherein the second scheduled route departs the origin at a second predetermined time which is after the first predetermined time;
iv. process the item according to the second scheduled route; and
V. send delayed item data indicating that the item and the passenger will arrive at different arrival times at the destination.

21-35. (canceled)
